(19) United States
(12) Patent Application Publication
(10) Pub. No.: US 2022/0012746 A1
(43) Pub. Date: Jan. 13, 2022

(54) REAL-TIME FINANCIAL PRODUCT SELECTION

(71) Applicant: ZILCH TECHNOLOGY LIMITED, London (GB)

(72) Inventor: Philip BELAMANT, London (GB)

(21) Appl. No.: 17/295,760

(22) PCT Filed: Nov. 21, 2019
(86) PCT No.: PCT/GB2019/053299

§ 371 Date: May 20, 2021

(30) Foreign Application Priority Data
Nov. 21, 2018 (GB) 1818974.6

(51) Int. Cl. G06Q 20/40; G06Q 20/32

(52) U.S. Cl. CPC G06Q 20/4097; G06Q 20/401; G06Q 20/3223; G06Q 20/3263

(57) ABSTRACT

A method and system are disclosed, for facilitating a financial transaction, the system comprising a retail device, an issuer device, a consumer device and a consumer token, all being in communication with one another, the system being adapted to add an additional stage to an existing payment process, the additional stage comprising steps of: temporarily pausing the existing payment process, seeking a response from a consumer via the consumer device, continuing the payment process with parameters which accord to the response from the consumer.

### FIELD OF THE INVENTION

The present inventive concept relates to apparatus and methods to facilitate real-time financial product selection and approval in the field of offline and online point of sale (POS) transactions.

### BACKGROUND TO THE INVENTION

A widely used system and method of paying for goods and services comprises a consumer token which a consumer presents to a merchant (retailer) when wishing to pay for a particular product or service. A widely-established token system operates under the label “EMV”. An EMV payment token tends to be issued by an issuer to a consumer—often in the form of a card. A consumer presents an EMV card to a merchant in order to pay for goods and/or services at the point of sale.

Preferably, steps are taken to identify that the EMV card is being presented by the person the card was intentionally issued to by the issuer. This can be done in a variety of ways. Traditionally, a signature would be sought by the merchant and compared to a signature extant on the card itself. More recently, “chip and pin” methods have been used.

Generally, EMV payment cards provide a direct link to a specific bank service, such as a bank current account or a credit account, etc.

EMV based payment applications such as M-CHIP 4 require a financial institution to issue a pre-defined card product to their customers, be it credit, debit, corporate, pre-paid etc.

In other words, there is usually a one to one relationship between a card and a financial service linked to that card. The implementation of these systems prevents decision by the customer at the time of a transaction as this decision is predetermined based on the card issued to the customer. This is not always what the consumer would wish as there may be a need to change this outcome whilst the transaction is taking place depending on what payment scheme or product is being offered by the issuing bank, in substantially real-time.

A number of companies have developed proprietary technologies which bypass the EMV systems and integrate with merchants directly. This allows for the customer to receive real-time product offers and to select their desired offering accordingly.

The drawbacks of such solutions are, generally, that they operate outside the commonplace payment system and thus require merchant integration, the development of separate clearing and settlement procedures and processes as well as contractual agreements. The net result is that these systems find it difficult to scale and tend to remain limited to particular geographic markets as deployment in other markets requires all of the work above to be repeated. The proprietary nature of these solutions leads to fragmentation of payment systems which can lead to a myriad of issues including commercial, legal and consumer acceptance.

Thus, there is a requirement for a solution which would use existing infrastructure and also provide the flexibility delivered by proprietary offerings.

### SUMMARY OF INVENTION

The present inventive concept provides a method of facilitating a payment, the method comprising adding an additional stage to an existing payment process, the additional stage comprising steps of: temporarily pausing the existing payment process, seeking a response from a consumer, continuing the payment process with parameters which accord to the response from the consumer.

For example, during a purchase transaction in a retail environment, a card transaction may be paused while the consumer is offered a chance to select an option. Once an option has been selected, the transaction proceeds on the basis of the option selected. As an example, options may include which bank account to debit the relevant sum from, or whether to pay the relevant sum by taking out a loan or by using a payment plan or the like.

The additional stage may be introduced at a point in the existing payment process when a card issuer is contacted to confirm that the transaction may proceed. During a substantially ordinary period during which such confirmation would usually take place, the consumer is asked for a response.

The consumer may be asked for a response via software on his or her mobile phone or other portable computing device.

Alternatively, a purchase transaction may take place remotely, for example via a web page. Web-based purchase transactions are often authenticated using an XML-based protocol, such as 3D Secure™ (sometimes referred to as 3DS). In general, an authentication method will ask a consumer to enter a password or verify using biometric data or the like in order to proceed with the transaction. In the present inventive concept, a further stage would be added as set out above. Thus, either an authentication step would be replaced by the additional stage of the present inventive concept or the additional stage of the present inventive concept would be in addition to the said authentication step.

The present inventive concept may be used by the customer to select a payment scheme of their choice at the time of authorisation.

For example, when an EMV transaction is effected, the use of a credit card BIN would result in the draw down from a pre-defined credit facility and the use of a debit card BIN would result in an account debit. In this inventive concept, the customer's token does not enforce a pre-determined outcome, as this is selected by the customer during the authorisation of the transaction.

The key advantage provided by the present inventive concept over previous methodologies is that the consumer is not expected to make a payment methodology decision prior to purchase but can rather do so at the time of purchase. The solution also allows the present methodology to appear to be embedded (integrated) with the merchant while actually being implemented away from the merchant.

The present inventive concept also provides a system for facilitating a financial transaction comprising a retail device, an issuer device, a consumer device and a consumer token, all being in communication with one another, the system being adapted to add an additional stage to an existing payment process, the additional stage comprising steps of: temporarily pausing the existing payment process, seeking a response from a consumer via the consumer device, continuing the payment process with parameters which accord to the response from the consumer.

The consumer token may comprise an EMV payment card. The consumer device may comprise a mobile phone or other portable computing device. The retail device may comprise a payment card reader. The issuer device may comprise a computing device. A key advantage of the present inventive concept is that the method may add functionality to an existing payment process. In other words, existing payment infrastructure can be used to add value; retailers et al. are not required to replace existing equipment or processes etc. in order for consumers to benefit from the advantages of the present inventive concept.

A further key advantage of the present inventive concept is that the method steps take place in substantially real time. This is in contrast to one particular known system which provides a single payment card and a choice of which account to debit, in which the choice of which account to debit is set in advance of a transaction taking place. In that scenario, a consumer would communicate his or her choice to the issuer and that choice would be used for transactions until a different choice is communicated. The present inventive concept introduces a much higher degree of flexibility, as well as the possibility of introducing different financial services at the point of purchase.

The token, data processing and storage device and a data communication device are programmed with a computer program adapted to perform functions such as customer verification as well as product selection and transaction authorisation.

Thus, an exemplary user experience may be as follows:
1. A consumer opens an implementation application and selects the merchant at which they intend to spend,
2. the system unlocks the payment token (belonging to the user) and enables (locks it) it for the merchant selected,
3. the system then finds and selects the highest paying affiliate link for this merchant and redirects the user to the merchant's website,
4. the consumer checks out (i.e. proceeds with the transaction) at the merchant's website using their payment token,
5. the merchant's payment provider checks to see if the payment token is registered for 3DS and, if it is, redirects the user to an embedded 3DS secure webpage (making it appear that the system is directly integrated to the merchant's webpage),
6. the system presents the customer with various payment options for the purchase (for example: pay now, pay over 6 weeks or pay over a longer period of time),
7. the consumer selects the payment methodology they would like to apply to the purchase,
8. the system applies this payment rule to the consumer's account and authenticates the 3DS call,
9. the transaction is routed through the payment network (e.g. MasterCard™) to the system at which point the selected billing is applied to the consumer's account (with that which was selected, above) and the transaction is authorised.

This differs from previous implementations, which would—upon the user selecting the merchant (step 1) above—present the user with different payment options for this purchase (pay now, pay over 6 weeks or pay over a longer period of time). At that point, the customer would select which payment methodology they would like to apply to their upcoming purchase, and the system would apply this payment rule to the payment token. In other words, the payment route would need to be pre-selected and approved, rather than being selected in real time as the transaction progresses.

### DETAILED DESCRIPTION OF THE INVENTION

Exemplary embodiments of the present inventive concept will now be described, with reference to the accompanying drawings, in which:

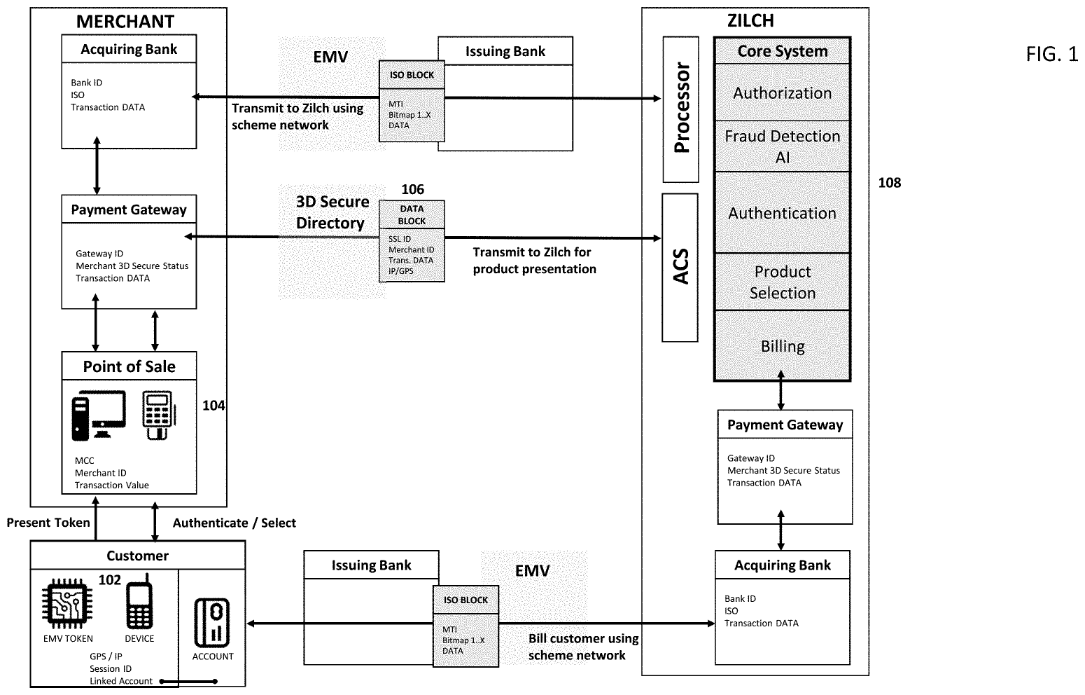

FIGS. 1 to 3 each show how the present inventive concept fits into an existing payment methodology, each Figure showing a different perspective.

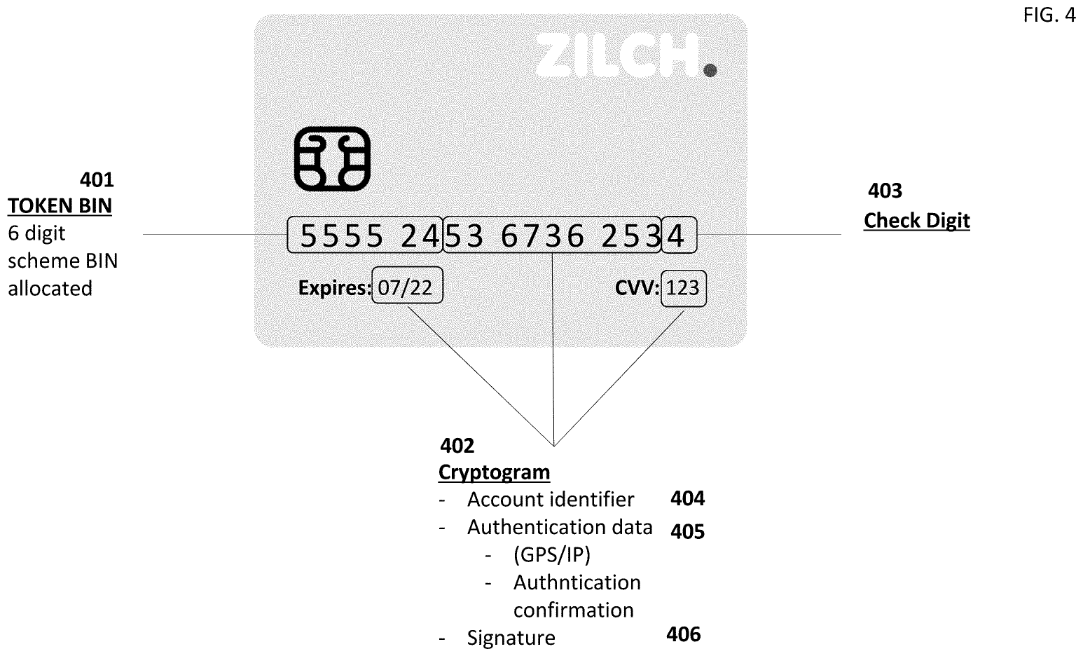

FIG. 4 shows an exemplary payment card in line with EMV standards.

FIG. 1 shows elements of a system and method to allow customers a real time payment product selection without the need for any change to merchant equipment or acquiring systems or to the customers current payment card or systems of the issuer providing said card. The system and method function over the top (OTT) of the current EMV and 3-D Secure (3DS) infrastructure. A customer smart phone or computer 102 could generate one or multiple tokens formatted in line with the EMV standard for cards, such as a 16 digit PAN (Primary Account Number), an expiry date and a CVV (Card Verification Value) as shown in FIG. 4.

Cryptographic keys may be used together with a symmetric or asymmetric algorithm to create an encrypted certificate containing information that can confirm the identity of the customer, the device on which the token was created and random fields which can be used to uniquely identify each transaction, prevent replays or other brute force or ‘man in the middle’ attacks.

At point of sale 104 there can be immediate acceptance of the proprietary EMV Token at all merchants both online and offline. The system and method make use of the embedded, encrypted information held within the EMV Token and the customer device information to authenticate a transaction.

The system and method make use of the 3DS infrastructure 106 to present an interactive product selection screen to the customer and capture their selection at the point of a transaction effecting. The system and method interrogate transaction information, merchant data and customer data to determine the risk profile of the transaction 108.

The system and method can increase their efficacy and performance as more and more clients contribute data. Customers' banking details can be captured and stored and used to facilitate automated payments of fees due or/and the repayments of loans granted.

Thus, the system and method can create financial flexibility for consumers without the need for multiple, pre-programmed tokens/products. The system and method can provide in-line decisions to be changed and/or modified post transaction to suit the customer. The system and method can include and/or be implemented using mobile technology with cloud-based processing, big data, artificial intelligence and data analysis, statistical correlation and inference techniques to combat fraud, and to minimise bad debt.

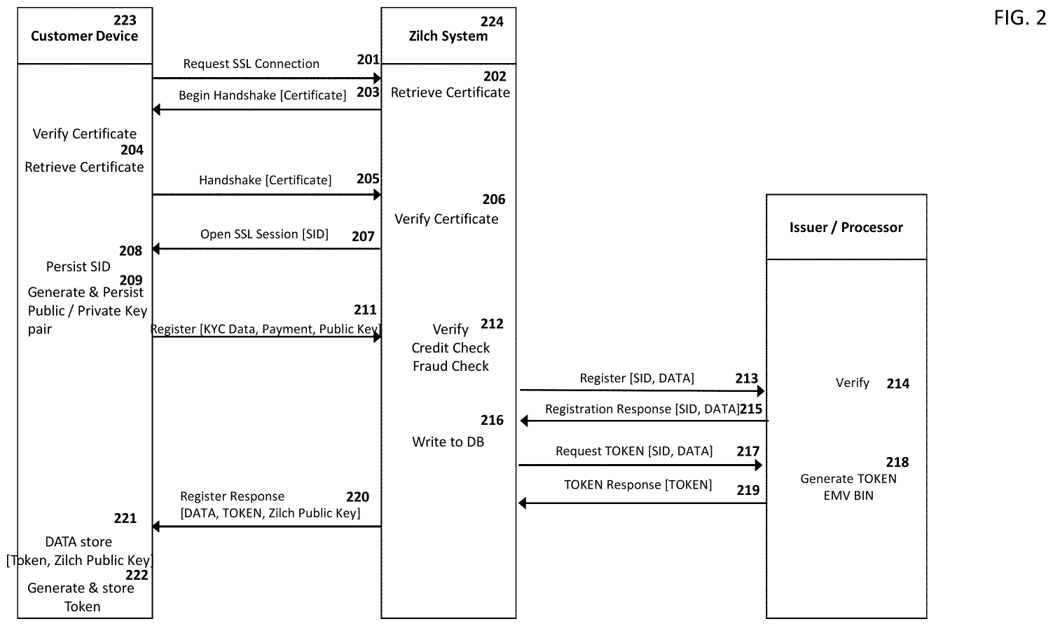

FIG. 2 shows steps which take place between a customer device 223, the system 224 and/or process of the present inventive concept (labelled “Zilch”), and an issuer/processor.

The system and method enables customers to use their mobile/computing device to register with the system 211 in order to securely transact, authenticate transactions and perform in-line product selection. Customers can download an application to their mobile or other computing device.

Customers can generate and store one or multiple tokens 222 formatted in line with the EMV standard for cards such as a 16 digit PAN (Primary Account Number), an expiry date and a CVV (Card Verification Value). The system and method also allows for the offline generation of a set of Public/Private cryptographic keys 208, 209 using the SHA-256 cryptographic algorithm.

The keys mentioned above can generate a cryptogram containing information that will confirm the identity of the customer, the device on which the token was created and random fields which can be used to uniquely identify each transaction, prevent replays or other brute force or ‘man in the middle’ attacks 221.

The system and method allow for the capturing and storing of customers' payment details 211 used to facilitate payments of fees due or/and the repayments of loans granted. The system and method can verify customer payment data 213, 214.

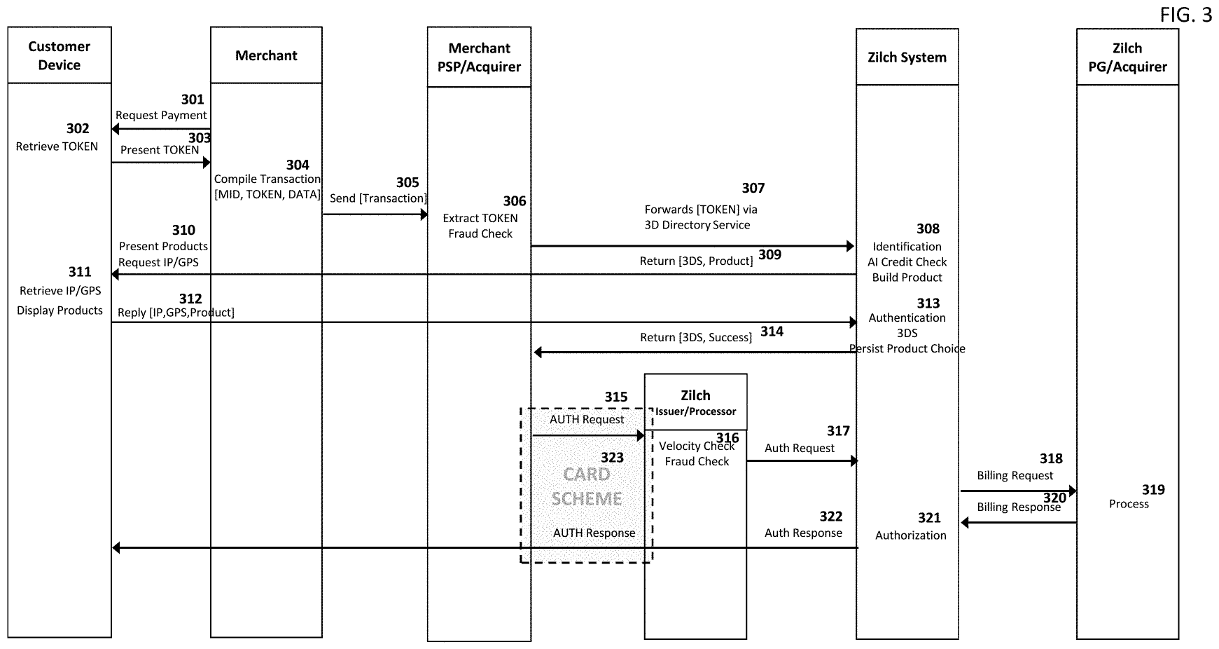

Turning to FIG. 3, the system and method of the present inventive concept allow customers to create a virtual fixed or variable card number 302 when they wish to perform a POS transaction, which is compliant with the EMV standards in term of both its message formats and processes followed to ensure interoperability and usage ubiquity. The system and method can morph data fields it requires such as mobile phone ID, customer account number and random data into a standard card format. This allows customers to present the generated token on check-out 303 at any on-line or off-line retailer as a EMV compliant payment card.

At POS the system and method either requires a 3DS secure process to be invoked or if 3DS is not available allows the customer to select the payment facility they require. The system and method intercept the 3DS secure process 309 as mentioned and presents to the customers product options 310 which can vary completely from the default option as determined by the card number (token) presented (BIN—Bank Identification Number).

The system and method thus allow customers to choose a financial product whilst performing the 3d secure process function 311/312. The transaction can continue with the transaction flow 315 once the new 3DS function process has completed.

The system and method also allows customers who could not use the 3DS function above to redefine the product option they wish to use after or before the transaction as completed. Customers could thus convert a POS purchase into a loan facility after the transaction has been effected at the POS. The system and method can credit the customer's bank account with the value of the loan selected by the customer after the transaction has completed or in-line depending on the configuration selected by the customer.

The system and method utilise all standard operating procedures set by EMV regarding message formats, process flows, reconciliation and settlement procedures, charge-back rules and regulations and other pre-defined financial and legal processes adhered to by EMV participants.

In FIG. 4 the system and method are shown to embed specific data into a cryptogram and repurposes the result to look and function as a standard EMV token. Thus, a process where a scheme issued BIN 401 is combined with a system generated cryptogram comprising 16 digits (making use of public/private key pair) generated using identification and authentication data such as, but not limited to an account identifier 404, authentication data 405, a signature 406 generated with the customers private key, and a check digit make up what would traditional be known as a PAN, CVV and Expiry date.

1. A method of facilitating a payment, the method comprising adding an additional stage to an existing payment process, the additional stage comprising steps of:
temporarily pausing the existing payment process, seeking a response from a consumer, continuing the payment process with parameters which accord to the response from the consumer.

2. A method of facilitating a payment according to claim 1, wherein the additional stage is introduced at a point in the existing payment process when a card issuer is contacted to confirm that the transaction may proceed.

3. A method of facilitating a payment according to claim 1, wherein the consumer is asked for a response via software on his or her mobile phone or other portable computing device.

4. A system for facilitating a financial transaction comprising a retail device, an issuer device, a consumer device and a consumer token, all being in communication with one another, the system being adapted to add an additional stage to an existing payment process, the additional stage comprising steps of: temporarily pausing the existing payment process, seeking a response from a consumer via the consumer device, continuing the payment process with parameters which accord to the response from the consumer.

5. A system according to claim 4, wherein the consumer token comprises an EMV payment card.

6. A system according to claim 4, wherein the consumer device comprises a mobile phone or other portable computing device.

7. A system according to claim 4, wherein the retail device comprises a payment card reader.

8. A system according to claim 4, wherein the issuer device comprises a computing device.
